(19) United States
(12) Patent Application Publication
(10) Pub. No.: US 2024/0375283 A1
(43) Pub. Date: Nov. 14, 2024

(54) METHOD, ELECTRONIC DEVICE AND COMPUTER READABLE STORAGE MEDIUM FOR CALIBRATING A ROBOT

(71) Applicant: ABB SCHWEIZ AG, Baden (CH)

(72) Inventors: Kun Chang, Shanghai (CN); Xu Su, Shanghai (CN)

(21) Appl. No.: 18/577,832

(22) PCT Filed: Sep. 7, 2021
(86) PCT No.: PCT/CN2021/116872

§ 371 Date: Jan. 9, 2024

(51) Int. Cl. B25J 9/16; B25J 13/08

(52) U.S. Cl. CPC B25J 9/1692; B25J 13/089

(57) ABSTRACT

A method, an electronic device, and a computer readable storage medium for calibrating a robot. The method includes obtaining a first set of data related to at least one of position and orientation of at least three calibration objects. The method includes determining a second set of data related to at least one of position and orientation of the at least three calibration objects when the target object is in a second state different from the first state; determining a transformation relationship between the first set of data and the second set of data; determining a calibrated object coordinate system based on the object coordinate system and the transformation relationship; and controlling the robot to process the target object in a predetermined way under the calibrated object coordinate system.

### FIELD

Embodiments of the present disclosure generally relate to a method for calibrating a robot.

### BACKGROUND

An industrial robot is used to perform a work, such as a surface treating of a target work object. A robot program comprises a plurality of instructions for controlling movements of the robot. For generating the robot program, positions and orientations of a path should be defined and then corresponding instructions can be generated based on the defined positions and orientations.

When programming a robot program, robot coordinate systems, including a world coordinate system, a robot coordinate system, a tool coordinate system, and a work object coordinate system, are used in determining positions and orientations of the path. After the robot program has been accomplished, the robot follows the corresponding instructions to perform the work. If the position and orientation of the work object changes, the robot program should be adjusted to adapt the changes. However, reprogramming the robot program is time-consuming and expensive. Therefore, there is a need for an approach to adapt the robot program to the changes in the position and orientation of the work object.

### SUMMARY

According to implementations of the subject matter described herein, there is provided a method for calibrating a robot to adapt the robot program to the changes in the position and orientation of the work object.

In a first aspect, there is provided a method for manipulating a robot. The method comprises: obtaining a first set of data related to at least one of position and orientation of at least three calibration objects, the at least three calibration objects being non-collinear to each other in an object coordinate system when a target object is in a first state, and the at least three calibration objects being in a fixed relation to the target object: determining a second set of data related to at least one of position and orientation of the at least three calibration objects when the target object is in a second state different from the first state; determining a transformation relationship between the first set of data and the second set of data: determining a calibrated object coordinate system based on the object coordinate system and the transformation relationship; and controlling the robot to process the target object in a predetermined way under the calibrated object coordinate system.

With these embodiments, the robot program can be simply adjusted to adapt the changes of the position and/or orientation of the target objects, without needing a complex calibration camera.

In some embodiments, each of the at least three calibration objects is one of a spherical structure, a hemispherical structure, a square structure, a rectangular structure or a triangle structure. The at least three calibration objects are selected to have a regular shape such that their spatial data can be determined easily when position and/or orientation of the target object changes.

In some embodiments, the at least three calibration objects are arranged on at least one of the target object and a fixture to which the target object is fixed. Since the target object and the fixture are fixed together, the at least three calibration objects can be distributed as needed according to different scenarios.

In some embodiments, the object coordinate system is a simulation coordinate system, and the first set of data are obtained from the simulation coordinate system; or the object coordinate system is a physical coordinate system, and the first set of data are determined by means of a camera or a probe of the robot in the physical coordinate system. With these embodiments, the positon and orientation data of the calibration objects can be determined in the first state.

In some embodiments, when the target object is in the second state, at least one of a position and an orientation of the target object is changed with respect to that of the first state.

In some embodiments, the transformation relationship comprises a transformation matrix between the first set of data and the second set of data; and wherein the transformation matrix comprises a translation matrix and a rotation matrix.

In some embodiments, the predetermined way comprises a path; and the path and an origin point of the object coordinate system meet a first relation; wherein the path and an origin point of the calibrated object coordinate system meet the first relation. With these embodiments, the path along which the robot moves relative to the origin point of the object coordinate system remains unchanged, thereby reprogramming is not needed.

In some embodiments, the target object is a special-shaped object. With these embodiments, the robot program can be simply adjusted to adapt the changes of the position and/or orientation of the special-shaped work object, without needing a complex calibration camera

In a second aspect, there is provided an electronic device. The electronic device comprises: at least one processing unit; and at least one memory coupled to the at least one processing unit and storing instructions executable by the at least one processing unit, the instructions, when executed by the at least one processing unit, causing the device to perform acts comprising: obtaining a first set of data related to at least one of position and orientation of at least three calibration objects, the at least three calibration objects being non-collinear to each other in an object coordinate system when a target object is in a first state, and the at least three calibration objects being in a fixed relation to the target object; determining a second set of data related to at least one of position and orientation of the at least three calibration objects when the target object is in a second state different from the first state; determining a transformation relationship between the first set of data and the second set of data; determining a calibrated object coordinate system based on the object coordinate system and the transformation relationship; and controlling the robot to process the target object in a predetermined way under the calibrated object coordinate system.

In some embodiments, each of the at least three calibration objects is one of a spherical structure, a hemispherical structure, a square structure, a rectangular structure or a triangle structure.

In some embodiments, the at least three calibration objects are arranged on at least one of the target object and a fixture to which the target object is fixed.

In some embodiments, the object coordinate system is a simulation coordinate system, and the first set of data are obtained from the simulation coordinate system; or the object coordinate system is a physical coordinate system, and the first set of data are determined by means of a camera or a probe of the robot in the physical coordinate system.

In some embodiments, when the target object is in the second state, at least one of a position and an orientation of the target object is changed with respect to that of the first state.

In some embodiments, the transformation relationship comprises a transformation matrix between the first set of data and the second set of data; and the transformation matrix comprises a translation matrix and a rotation matrix.

In some embodiments, the predetermined way comprises a path; and the path and an origin point of the object coordinate system meet a first relation; wherein the path and an origin point of the calibrated object coordinate system meet the first relation.

In some embodiments, the target object is a special-shaped object.

In a third aspect, there is provided a computer readable storage medium. The computer readable storage medium having computer readable program instructions stored thereon which, when executed by a processing unit, cause the processing unit to perform acts comprising: obtaining a first set of data related to at least one of position and orientation of at least three calibration objects, the at least three calibration objects being non-collinear to each other in an object coordinate system when a target object is in a first state, and the at least three calibration objects being in a fixed relation to the target object; determining a second set of data related to at least one of position and orientation of the at least three calibration objects when the target object is in a second state different from the first state; determining a transformation relationship between the first set of data and the second set of data; determining a calibrated object coordinate system based on the object coordinate system and the transformation relationship; and controlling the robot to process the target object in a predetermined way under the calibrated object coordinate system.

In some embodiments, each of the at least three calibration objects is one of a spherical structure, a hemispherical structure, a square structure, a rectangular structure or a triangle structure.

In some embodiments, the at least three calibration objects are arranged on at least one of the target object and a fixture to which the target object is fixed.

In some embodiments, the object coordinate system is a simulation coordinate system, and the first set of data are obtained from the simulation coordinate system; or wherein the object coordinate system is a physical coordinate system, and the first set of data are determined by means of a camera or a probe of the robot in the physical coordinate system.

In some embodiments, when the target object is in the second state, at least one of a position and an orientation of the target object is changed with respect to that of the first state.

In some embodiments, the transformation relationship comprises a transformation matrix between the first set of data and the second set of data; and the transformation matrix comprises a translation matrix and a rotation matrix.

In some embodiments, the predetermined way comprises a path; and the path and an origin point of the object coordinate system meet a first relation; wherein the path and an origin point of the calibrated object coordinate system meet the first relation.

In some embodiments, the target object is a special-shaped object.

The Summary introduces a selection of concepts in a simplified form that are further described below in the Detailed Description. The Summary is not intended to identify key features or essential features of the subject matter described herein, nor is it intended to be used to limit the scope of the subject matter described herein.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example environment in which embodiments of the present disclosure may be implemented;

FIG. 2 illustrates a flowchart of an example process for calibrating a robot; and

FIG. 3 illustrates a block diagram of an example computing system/device suitable for implementing example embodiments of the present disclosure.

Throughout the drawings, the same or similar reference symbols refer to the same or similar elements.

### DETAILED DESCRIPTION OF IMPLEMENTATIONS

Principles of the subject matter described herein will now be described with reference to some example implementations. It should be understood that these implementations are described only for the purpose of illustration and to help those skilled in the art to better understand and thus implement the subject matter described herein, without suggesting any limitations to the scope of the subject matter disclosed herein.

As used herein, the term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

It should be further understood that the terms “comprises”, “comprising”, “has”, “having”, “includes” and/or “including”, when used herein, specify the presence of stated features, elements, and/or components, etc., but do not preclude the presence or addition of one or more other features, elements, components and/or combinations thereof.

During operation, the position and orientation of the work objects may be changed for some reasons, and the robot program should adapt the changes. In order to avoid the time-consuming and expensive reprogramming, it is beneficial to perform a calibration process for the robot program to adapt the changes.

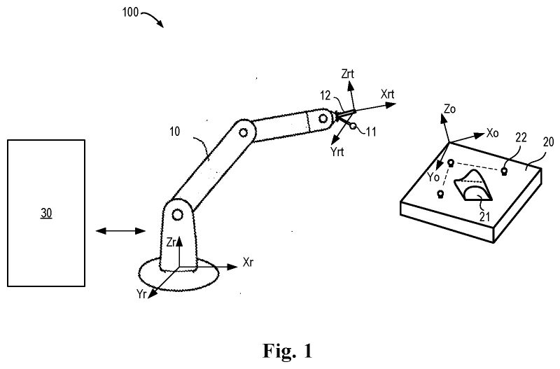

FIG. 1 illustrates an example environment in which embodiments of the present disclosure may be implemented. A robot 10 is used to process a target object 21, such as a special-shaped object, fixed to a fixture 20. The fixture 20 and the target object 21 are arranged within a working range of the robot 10. The robot 10 has an end effector 12 for processing the target object 21. In some embodiments, the robot 10 may be used in multiple applications, such as fettling, debarring, milling, sawing, grinding and drilling, arc welding, water jet cutting, laser cutting, gluing and assembly.

In some embodiments, the robot 10 may be equipped with a probe 11 (as shown in FIG. 1) or a camera (not shown) for determining the position and/or orientation information related to the calibration objects 22, which will be discussed later.

A controller 30 or a computing system/device may be used to control the robot to process the target object 21. In addition, when the position and orientation of the target objects 21 changes, the controller 30 may adjust the robot program such that the robot program does not need to be reprogrammed. The controller 30 may be a general-purpose computer, an industrial personal computer, a physical computing device, or may be practiced in distributed cloud computing environments where tasks are performed by remote processing devices that are linked through a communication network.

As shown in FIG. 1, there are a robot coordinate system (Xr, Yr, Zr), a tool coordinate system (Xrt, Yrt, Zrt), and a work object coordinate system (Xo, Yo, Zo). Programming the robot program in the work object coordinate system (Xo, Yo, Zo) is readily understood by a programmer. If the position and/or orientation of the target object 21 changes, it is expected that the robot program can be simply adjusted to adapt the changes.

For a special-shaped work object fixed to the fixture 20, if its position and/or orientation changes, it is difficult to obtain the changed position and/or orientation of the special-shaped work object. Traditionally, a calibration camera is used to process three-dimensional images of the special-shaped work object to obtain the position and/or orientation of the special-shaped work object. However, this calibration camera is expensive, and the image recognition of the calibration camera lasts for a long time.

The embodiments of present disclosure provides a method for manipulating the robot, which can reduce the cost of calibrating the work object coordinate system, and make the adjustment of the robot program easier. As such, it is possible to make the robot program applicable to the calibrated work object coordinate system.

At least three calibration objects 22, which are in a fixed relation to the target object 21, are arranged. As shown in FIG. 1, the at least three calibration objects 21 are non-collinear to each other in the object coordinate (Xo, Yo, Zo).

In some embodiments, the at least three calibration objects 22 may be arranged on the fixture 20. In other embodiments, the at least three calibration objects 22 may be arranged on the target object 21. In other embodiments, the at least three calibration objects 22 may be arranged on the target object 21 and the fixture 20.

In some embodiments, each of the at least three calibration objects 22 is one of a spherical structure, a hemispherical structure, a square structure, a rectangular structure and a triangle structure. It is to be understood that the shape of the calibration objects 22 can be any other shape as long as its position and/or orientation data can be determined easily.

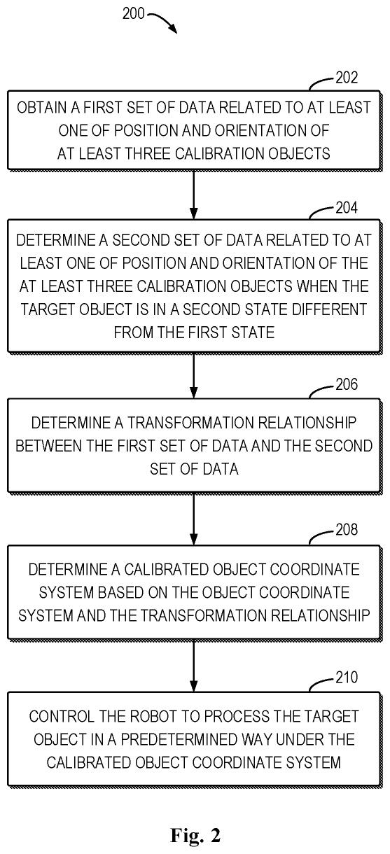

FIG. 2 illustrates a flowchart of an example process for calibrating the robot 10.

At block 202, the controller 30 obtains a first set of data P related to at least one of position and orientation of the at least three calibration objects 22 when the target object 21 is in a first state.

In some embodiments, the object coordinate system (Xo, Yo, Zo) is a simulation coordinate system. In this case, the first set of data may be obtained from a simulation data of the robot 10 and the target object 22 in the simulation coordinate system.

In other embodiments, the object coordinate system (Xo, Yo, Zo) is a physical coordinate system. In this case, the first set of data P can be determined by means of the camera or the probe 11 of the robot 10 in the physical coordinate system.

The camera (not shown) may obtain images containing the at least three calibration objects 22 and then an image recognition process may be performed so as to obtain the position and/or orientation of the at least three calibration objects 22. The image recognition process may be performed by the controller 30 or performed by a separate image processing device communicatively connected to the controller 30.

When the probe 11 is moved and attached to each of the at least three calibration objects 22, the position and/or orientation of the at least three calibration objects 22 may be obtained by a known way in the art.

At block 204, the controller 30 determines a second set of data Q related to at least one of position and orientation of the at least three calibration objects 22 when the target object 21 is in a second state. The second state is different from the first state. In some embodiments, when the target object 21 is in the second state, at least one of the position and the orientation of the target object 21 changes with respect to that of the first state.

At block 206, the controller 30 determines a transformation relationship between the first set of data P and the second set of data Q. In some embodiments, the transformation relationship may comprise a transformation matrix between the first set of data P and the second set of data Q. In some embodiments, the transformation matrix may comprise a translation matrix T and a rotation matrix R determined based on a rigid transformation theory.

In some embodiments, the transformation relationship between the first and second sets of data can be expressed as

$$R * P + T = Q \qquad ( 1 )$$

where R is a 3×3 rotation matrix, and T is a translation matrix. Theoretically, the translation matrix T is 3×N matrix, and N is the number of the calibration objects 21. That is, N is an integer equal to or larger than 3. In some embodiments, the first and second sets of data P, Q and the translation matrix T may be in the form of:

$$[ \begin{matrix}{x}_{1} & {x}_{2} & {x}_{3} & ⋯ & {x}_{N} \\ {y}_{1} & {y}_{2} & {y}_{3} & ⋯ & {y}_{N} \\ {z}_{1} & {z}_{2} & {z}_{3} & ⋯ & {z}_{N}\end{matrix} ] .$$

Based on the above equation (1), the controller 30 may find the centroids (Cent_{P}, Cent_{Q}) of the first and second sets of data P, Q by the following equations (2)-(3):

$${Cent}_{P} = \frac{1}{N} {\sum }_{i = 1}^{N} {P}_{i} \qquad ( 2 )$$

$${Cent}_{Q} = \frac{1}{N} {\sum }_{i = 1}^{N} {Q}_{i} \qquad ( 3 )$$

where Pᵢ is the i^{th} data in the first set of data P, and Qᵢ is the i^{th} data in the second set of data Q. Each of Pi and Qi may be a 3×1 vectors, e.g.,

$$[ \begin{matrix}x \\ y \\ z\end{matrix} ] .$$

The controller 30 may then determine the rotation matrix R by using a Singular Value Decomposition (SVD) method. The SVD may decompose a matrix H into three sub-matrixes: SVD(H)=[U, S, V]. Therefore, the rotation matrix R may be determined based on the following equations (4)-(5):

$$H = ( P - {Cent}_{P} ) {( Q - {Cent}_{Q} )}^{T} \qquad ( 4 )$$

$$S V D ( H ) = [ U , S , V ] \qquad ( 5 )$$

$$R = {VU}^{T} \qquad ( 6 )$$

Where the matrix H is a familiar covariance matrix.

The controller 30 may determine the translation matrix T based on the equations (1), (2), (3) and (6). The translation matrix T can be determined by equation (7):

$$T = {Cent}_{Q} - R * {Cent}_{P} \qquad ( 7 )$$

In this way, the transformation relationship has been determined. It is to be understood that any other approach can be used to determine the transformation relationship between the first and second set of data P, Q.

At block 208, the controller 30 determines a calibrated object coordinate system (Xo′, Yo′, Zo′) based on the object coordinate system (Xo, Yo, Zo) and the transformation relationship by the following equation:

$$( {Xo}^{′} , {Yo}^{′} , {Zo}^{′} ) = [ \begin{matrix} & R & & & & T & \\ 1 & & 1 & & 1 & & 1\end{matrix} ] \times ( Xo , Yo , Zo ) \qquad ( 8 )$$

At block 210, the controller 30 controls the robot 10 to process the target object 21, e.g., the special-shaped work object, in a predetermined way under the calibrated object coordinate system (Xo′, Yo′, Zo′).

In some embodiments, the predetermined way comprises a path. The path and an origin point of the object coordinate system (Xo, Yo, Zo) meet a first relation. Further, under the calibrated object coordinate system (Xo′, Yo′, Zo′), the path and an origin point of the calibrated object coordinate system (Xo′, Yo′, Zo′) meet the first relation.

In this way, when the position and/or orientation of the target object 21 changes, the robot program does not need to be reprogrammed. The robot program is applicable to the calibrated coordinate system as the transformation relationship is determined.

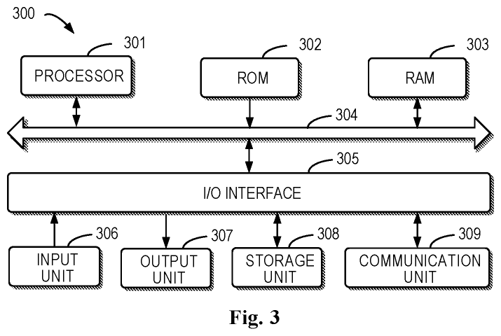

FIG. 3 illustrates a block diagram of an example computing system/device 300 suitable for implementing example embodiments of the present disclosure. The system/device 300 can be implemented as or implemented in the controller 30 of FIG. 1. The system/device 300 may be a general-purpose computer, a physical computing device, or a portable electronic device, or may be practiced in distributed cloud computing environments where tasks are performed by remote processing devices that are linked through a communication network. The system/device 300 can be used to implement the process 200 of FIG. 2.

As depicted, the system/device 300 includes a processor 301 which is capable of performing various processes according to a program stored in a read only memory (ROM) 302 or a program loaded from a storage unit 308 to a random access memory (RAM) 303. In the RAM 303, data required when the PROCESSOR 301 performs the various processes or the like is also stored as required. The PROCESSOR 301, the ROM 302 and the RAM 303 are connected to one another via a bus 304. An input/output (I/O) interface 305 is also connected to the bus 304.

The processor 301 may be of any type suitable to the local technical network and may include one or more of the following: general purpose computers, special purpose computers, microprocessors, digital signal processors (DSPs), graphic processing unit (GPU), co-processors, and processors based on multicore processor architecture, as non-limiting examples. The system/device 300 may have multiple processors, such as an application-specific integrated circuit chip that is slaved in time to a clock which synchronizes the main processor.

A plurality of components in the system/device 300 are connected to the I/O interface 305, including an input unit 306, such as a keyboard, a mouse, or the like; an output unit 307 including a display such as a cathode ray tube (CRT), a liquid crystal display (LCD), or the like, and a loudspeaker or the like; the storage unit 308, such as a disk and optical disk, and the like; and a communication unit 309, such as a network card, a modem, a wireless transceiver, or the like. The communication unit 309 allows the system/device 300 to exchange information/data with other devices via a communication network, such as the Internet, various telecommunication networks, and/or the like.

The methods and processes described above, such as the process 200, can also be performed by the processor 301. In some embodiments, the process 200 can be implemented as a computer software program or a computer program product tangibly included in the computer readable medium, e.g., storage unit 308. In some embodiments. the computer program can be partially or fully loaded and/or embodied in the system/device 300 via ROM 302 and/or communication unit 309. The computer program includes computer executable instructions that are executed by the associated processor 301. When the computer program is loaded to RAM 303 and executed by the PROCESSOR 301, one or more acts of the process 200 described above can be implemented. Alternatively, PROCESSOR 301 can be configured via any other suitable manner (e.g., by means of firmware) to execute the process 200 in other embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof.

The present disclosure also provides a computer readable storage medium having computer readable program instructions stored thereon which, when executed by a processing unit, cause the processing unit to perform the methods/processes as described above. A computer readable storage medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer readable program instructions for carrying out methods disclosed herein may be written in any combination of one or more programming languages. The program instructions may be provided to a processor or controller of a general purpose computer, special purpose computer, or other programmable data processing apparatus, such that the program instructions, when executed by the processor or controller, cause the functions/operations specified in the flowcharts and/or block diagrams to be implemented. The program instructions may execute entirely on a computer, partly on the computer, as a stand-alone software package, partly on the computer and partly on a remote computer or entirely on the remote computer or server. The program instructions may be distributed on specially-programmed devices which may generally be referred to herein as “modules”.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. A method for manipulating a robot comprising:
obtaining a first set of data related to at least one of position and orientation of at least three calibration objects, the at least three calibration objects being non-collinear to each other in an object coordinate system when a target object is in a first state, and the at least three calibration objects being in a fixed relation to the target object;
determining a second set of data related to at least one of position and orientation of the at least three calibration objects when the target object is in a second state different from the first state;
determining a transformation relationship between the first set of data and the second set of data;
determining a calibrated object coordinate system based on the object coordinate system and the transformation relationship; and
controlling the robot to process the target object in a predetermined way under the calibrated object coordinate system.

2. The method of claim 1, wherein each of the at least three calibration objects is one of a spherical structure, a hemispherical structure, a square structure, a rectangular structure or a triangle structure.

3. The method of claim 1, wherein the at least three calibration objects are arranged on at least one of the target object and a fixture to which the target object is fixed.

4. The method of claim 1, wherein the object coordinate system is a simulation coordinate system, and the first set of data are obtained from the simulation coordinate system; or
wherein the object coordinate system is a physical coordinate system, and the first set of data are determined by means of a camera or a probe of the robot in the physical coordinate system.

5. The method of claim 1, wherein, when the target object is in the second state, at least one of a position and an orientation of the target object is changed with respect to that of the first state.

6. The method of claim 1, wherein the transformation relationship comprises a transformation matrix between the first set of data and the second set of data; and
wherein the transformation matrix comprises a translation matrix and a rotation matrix.

7. The method of claim 1, wherein the predetermined way comprises a path; and
wherein the path and an origin point of the object coordinate system meet a first relation;
wherein the path and an origin point of the calibrated object coordinate system meet the first relation.

8. The method of claim 1, wherein the target object is a special-shaped object.

9. An electronic device, comprising:
at least one processing unit; and
at least one memory coupled to the at least one processing unit and storing instructions executable by the at least one processing unit, the instructions, when executed by the at least one processing unit, causing the device to perform acts comprising:
obtaining a first set of data related to at least one of position and orientation of at least three calibration objects, the at least three calibration objects being non-collinear to each other in an object coordinate system when a target object is in a first state, and the at least three calibration objects being in a fixed relation to the target object;
determining a second set of data related to at least one of position and orientation of the at least three calibration objects when the target object is in a second state different from the first state;
determining a transformation relationship between the first set of data and the second set of data;
determining a calibrated object coordinate system based on the object coordinate system and the transformation relationship; and
controlling the robot to process the target object in a predetermined way under the calibrated object coordinate system.

10. The electronic device of claim 9, wherein each of the at least three calibration objects is one of a spherical structure, a hemispherical structure, a square structure, a rectangular structure or a triangle structure.

11. The electronic device of claim 9, wherein the at least three calibration objects are arranged on at least one of the target object and a fixture to which the target object is fixed.

12. The electronic device of claim 9, wherein the object coordinate system is a simulation coordinate system, and the first set of data are obtained from the simulation coordinate system; or
wherein the object coordinate system is a physical coordinate system, and the first set of data are determined by means of a camera or a probe of the robot in the physical coordinate system.

13. The electronic device of claim 9, wherein, when the target object is in the second state, at least one of a position and an orientation of the target object is changed with respect to that of the first state.

14. The electronic device of claim 9, wherein the transformation relationship comprises a transformation matrix between the first set of data and the second set of data; and
wherein the transformation matrix comprises a translation matrix and a rotation matrix.

15. The electronic device of claim 9, wherein the predetermined way comprises a path; and
wherein the path and an origin point of the object coordinate system meet a first relation;
wherein the path and an origin point of the calibrated object coordinate system meet the first relation.

16. The electronic device of claim 9, wherein the target object is a special-shaped object.

17. A computer readable storage medium having computer readable program instructions stored thereon which, when executed by a processing unit, cause the processing unit to perform acts comprising:
obtaining a first set of data related to at least one of position and orientation of at least three calibration objects, the at least three calibration objects being non-collinear to each other in an object coordinate system when a target object is in a first state, and the at least three calibration objects being in a fixed relation to the target object;
determining a second set of data related to at least one of position and orientation of the at least three calibration objects when the target object is in a second state different from the first state;
determining a transformation relationship between the first set of data and the second set of data;
determining a calibrated object coordinate system based on the object coordinate system and the transformation relationship; and
controlling the robot to process the target object in a predetermined way under the calibrated object coordinate system.

18. The computer readable storage medium of claim 17, wherein each of the at least three calibration objects is one of a spherical structure, a hemispherical structure, a square structure, a rectangular structure or a triangle structure.

19. The computer readable storage medium of claim 17, wherein the at least three calibration objects are arranged on at least one of the target object and a fixture to which the target object is fixed.

20. The computer readable storage medium of claim 17, wherein the object coordinate system is a simulation coordinate system, and the first set of data are obtained from the simulation coordinate system; or
wherein the object coordinate system is a physical coordinate system, and the first set of data are determined by means of a camera or a probe of the robot in the physical coordinate system.

21. The computer readable storage medium of claim 17, wherein, when the target object is in the second state, at least one of a position and an orientation of the target object is changed with respect to that of the first state.

22. The computer readable storage medium of claim 17, wherein the transformation relationship comprises a transformation matrix between the first set of data and the second set of data; and
wherein the transformation matrix comprises a translation matrix and a rotation matrix.

23. The computer readable storage medium of claim 17, wherein the predetermined way comprises a path; and
wherein the path and an origin point of the object coordinate system meet a first relation;
wherein the path and an origin point of the calibrated object coordinate system meet the first relation.

24. The computer readable storage medium of claim 17, wherein the target object is a special-shaped object.
